(19) United States
(12) Patent Application Publication
(10) Pub. No.: US 2008/0165881 A1
(43) Pub. Date: Jul. 10, 2008

(54) Method for Accessing Channels in OFDMA Mobile Multihop Relay Networks

(76) Inventors: Zhifeng Tao, Allston, MA (US); Koon Hoo Teo, Lexington, MA (US); Jinyun Zhang, Cambridge, MA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 11/850,262

(22) Filed: Sep. 5, 2007

Related U.S. Application Data
(60) Provisional application No. 60/883,907, filed on Jan. 8, 2007.

(51) Int. Cl. H04B 7/02

(52) U.S. Cl. 375/267

(57) ABSTRACT

A method accesses channels in an OFDMA mobile multihop relay wireless network. The method partitions a downlink sub-frame into at least one downlink access zone and a set of downlink relay zones. The uplink subframe is partitioned into at least one uplink access zone and a set of uplink relay zones. During the downlink access zone, the base station and the relay stations transmit only to the set of mobile stations. During the downlink relay station, the base station and the set of relay stations communicate with each other, while the mobile stations are idle. During the uplink access zone, the set of mobile stations transmit only to the set of relay stations and the base station. During the uplink relay station, the base station and the set of relay stations communicate with each other, while the mobile stations are idle.

### RELATED APPLICATION

This application claims priority to and incorporates by reference herein in its entirety U.S. Provisional Patent Application Ser. No. 60/883,907, “Adaptive Frame Structure for a Mobile Multi-Hop Relay Network” filed by Tao on Jan. 8, 2007.

### FIELD OF THE INVENTION

This invention relates generally to mobile multihop (MMR) wireless networks using OFDMA, and more particularly to a frame structure used by base stations (BS), relay stations (RS), and mobile stations (MS) in such networks.

### BACKGROUND OF THE INVENTION

OFDM

Orthogonal frequency-division multiplexing (OFDM) is frequently used to reduce multi-path interference in a physical layer (PHY) of channels of wireless communication networks. OFDM is specified for a number of wireless communications standards, e.g., IEEE 802.11a/g, and IEEE 802.16d/16e, “IEEE Standard for Local and Metropolitan Area Networks—Part 16: Air Interface for Fixed Broadband Wireless Access Systems,” IEEE Computer Society and the IEEE Microwave Theory and Techniques Society, October 2004, and “IEEE Standard for Local and Metropolitan Area Networks—Part 16: Air interface for Fixed Broadband Wireless Access Systems, Amendment 2: Physical and Medium Access Control Layers for Combined Fixed and Mobile Operation in Licensed Bands,” IEEE Computer Society and the IEEE Microwave Theory and Techniques Society, February 2006, both incorporated herein by reference.

OFDMA

Based on the OFDM, orthogonal frequency division multiple access (OFDMA) has been developed. With OFDMA a separate sets of orthogonal tones (frequencies) are allocated to multiple transceivers (users) so that these transceivers can engage in parallel communication. For example, the IEEE 802.16/16e standard has adopted OFDMA as the multiple channel access mechanism for non-line-of-sight (NLOS) communications in frequency bands below 11 GHz.

Single Hop Point-to-MultiPoint (PMP) Network Topology

As shown in FIG. 1, the current OFDMA-based cellular wireless network, e.g., IEEE 802.16, confines its operation to a point-to-multi-point network (PMP). The network includes a base station (BS) and multiple mobile stations (MS). The base station is connected to an infrastructure or ‘backbone’ 101 by wired or wireless links. The BS manages all communications between the MSs, via the infrastructure.

Frame Structure for Single Hop Point-to-MultiPoint (PMP) Network

FIG. 2 shows a frame structure 200 used for channel access by the BS and MS in both the time and frequency domain in an OFDMA-based time-division multiplexing (TDD) 802.16 PMP network. The basic unit of resource for allocation in OFDM A is slot. A slot has an associated time (k) and subchannel (s). Each slot can carry one or more than one symbols. The base station partitions time into contiguous frames 210 including a downlink (DL) and an uplink (UL) subframe.

During the downlink subframe, all traffic must be in the downlink direction, i.e., from the base station to the mobile stations. During the uplink subframe, all traffic must be in the uplink direction, i.e., from the mobile stations to the base station.

The DL subframe starts with a preamble 220, which enables the mobile stations to perform synchronization and channel estimation. The first subchannel in the first two OFDMA symbols in the downlink is the frame control header (FCH) 202. The FCH is transmitted using QPSK rate ½ with four repetitions. The FCH specifies a length of the immediately succeeding downlink MAP (DL-MAP) message and the repetition, coding used for DL-MAP. The BS uses the downlink MAP (DL-MAP) and an uplink MAP (UL-MAP) message to notify MSs of the resources allocated to data bursts in the downlink and uplink direction, respectively, within the current frame. The bursts are associated with connection identifiers (CID). Based upon a schedule received from the BS, each MS can determine when (i.e., OFDMA symbols) and where (i.e., subchannels) the MS should transceive (transmit or receive) with the BS. The first subchannels 203 in the UL subframe are used for ranging.

The receive/transmit gap (RTG) separates the frames, and the transmit transition gap (TTG) separates the subframes within a frame. This enables the transceivers to switch between transmit and receive modes.

PMP Network Zones

The IEEE 802.16 standard also specifies the use of zones for PMP networks. According to the standard, a zone refers to a number of contiguous OFDMA symbols (slots) in the downlink or uplink subframe that use the same permutation. A permutation is a mapping between logical subchannels and physical subcarriers. Each subcarrier is an allocated band of frequencies. The IEEE 802.16 standard defines a small number of permutations. The BS informs the MSs of the location, format and length of each zone by using the information elements (IE) in the DL-MAP and UL-MAP.

In conventional PMP networks, zones enable a variety of physical layer configurations, i.e., logical channel to physical subcarrier mappings. Zones also accommodate the use of devices with different antenna capabilities in the same network, such as single antenna devices, and multiple antenna devices,

It is desired to use zones to improve performance in MMR networks.

For sake of clarify and brevity, some terminologies and acronyms are defined herein as follows,

Subscriber station (SS): Generalized equipment set providing connectivity between subscriber (user) equipment (UE) and a base station (BS).

Mobile station (MS): A station in mobile service intended to be used while in motion or during halts at unspecified points. The MS is always a subscriber station (SS) unless specifically expected otherwise in the standard.

Relay station (RS): A station that conforms to the IEEE Std 802.16j standard and whose functions are 1) to relay data and possibly control information between other stations, and 2) to execute processes that indirectly support mobile multihop relay networks, see “Harmonized definitions and terminology for IEEE 802.16j Mobile Multihop Relay,” IEEE 802.16j-06/014r1, Oct. 2006, incorporated herein by reference.

Access station: The station that is at the point of direct access into the network for a given MS or RS. Note that an access station can be a BS or a RS. Superordinate station and access station can be used interchangeably.

Subordinate RS: A RS is a subordinate RS of another station when that station serves as the access station for that RS.

Relay link: The wireless link that directly connects an access station with its subordinate RS.

Access link: The link between MS and its access RS is known as access link.

### SUMMARY OF THE INVENTION

A method accesses channels in an OFDMA mobile multihop relay wireless network. The method partitions a downlink subframe into at least one downlink access zone and a set of downlink relay zones.

The uplink subframe is partitioned into at least one uplink access zone and a set of uplink relay zones. During the downlink access zone, the base station and the relay stations transmit only to the set of mobile stations.

During the downlink relay station, the base station and the set of relay stations communicate with each other, while the mobile stations are idle. During the uplink access zone, the set of mobile stations transmit only to the set of relay stations and the base station. During the uplink relay station, the base station and the set of relay stations communicate with each other, while the mobile stations are idle.

### BRIEF DESCRIPTION OF THE DRAWINGS

FIG. 1 is a diagram of a conventional OFDMA-based point-to-multipoint (PMP) wireless network;

FIG. 2 is a block diagram of a frame structure for the network of FIG. 1;

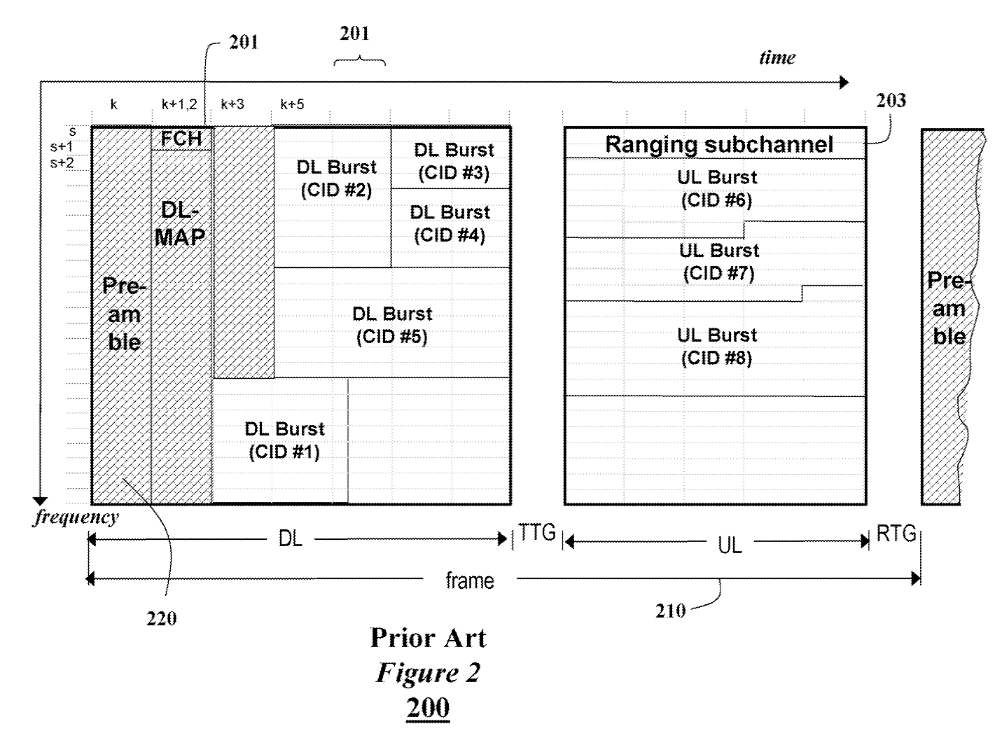

FIG. 3A is a diagram of a mobile multihop relay (MMR) wireless network according to an embodiment of the invention;

FIG. 3B is a block diagram of a frame structure for the network of FIG. 3A;

FIG. 3C is a block diagram of a frame partitioned into zones according to an embodiment of the invention;

FIG. 4 is a block diagram of frame structures for an inter-frame mode without frequency reuse according to an embodiment of the invention;

FIG. 5 is a block diagram of frame structures for an inter-frame mode with frequency reuse and a strict sense of downlink and uplink transmission according to an embodiment of the invention;

FIG. 6 is a block diagram of frame structures for an inter-frame mode with frequency reuse and a relaxed sense of downlink and uplink transmission according to an embodiment of the invention;

FIG. 7 is a block diagram of frame structures for an inter-frame mode with ambles according to an embodiment of the invention;

FIG. 8 is a block diagram of a frame structure for an intra-frame mode without frequency reuse according to an embodiment of the invention;

FIG. 9 is a block diagram of a frame structure for an intra-frame mode with frequency reuse according to an embodiment of the invention;

FIG. 10 is a block diagram of a frame structure for an intra-frame mode with frequency reuse according to an embodiment of the invention; and

FIG. 11 is a block diagram of a frame structure for an intra-frame mode with ambles according to an embodiment of the invention.

### DETAILED DESCRIPTION OF THE PREFERRED EMBODIMENT

Mobile Multihop Relay Network Topology

Due to a significant reduction of signal strength, the coverage area of a PMP wireless network is often of limited geographical size. In addition, blocking and random fading frequently result in areas of poor reception, or even dead spots within the coverage area. Conventionally, this problem is addressed by deploying base stations in dense manner. However, the high cost of BSs and potential aggravation of interference, among the base stations, make this approach undesirable.

As an alternative, a mobile multihop relay (MMR) network can be used. Relatively low cost relay stations can extend and improve service, and eliminate dead spots at a lower cost than base stations.

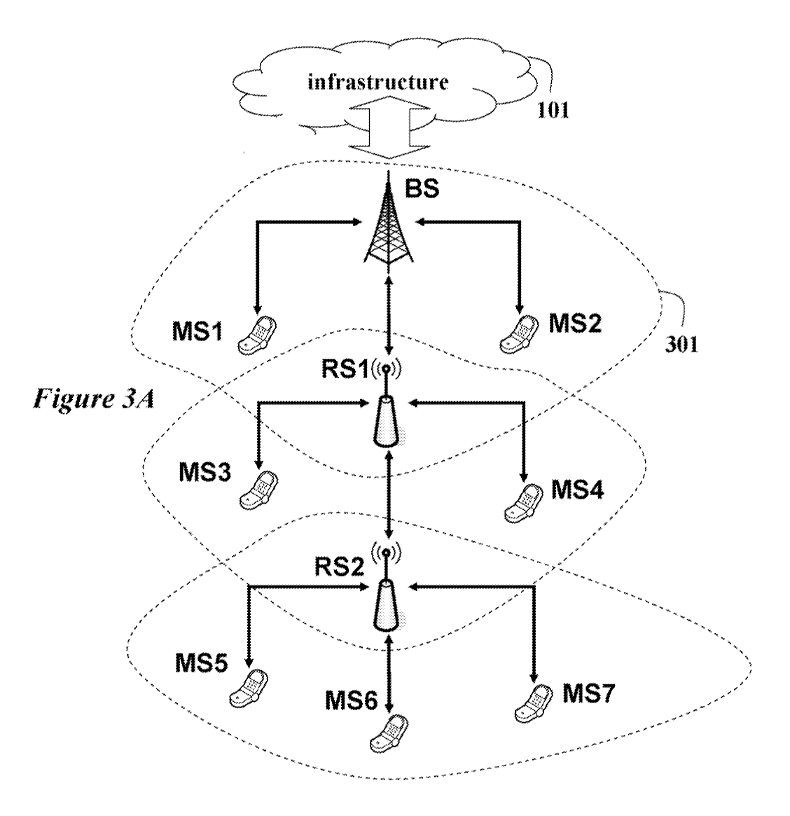

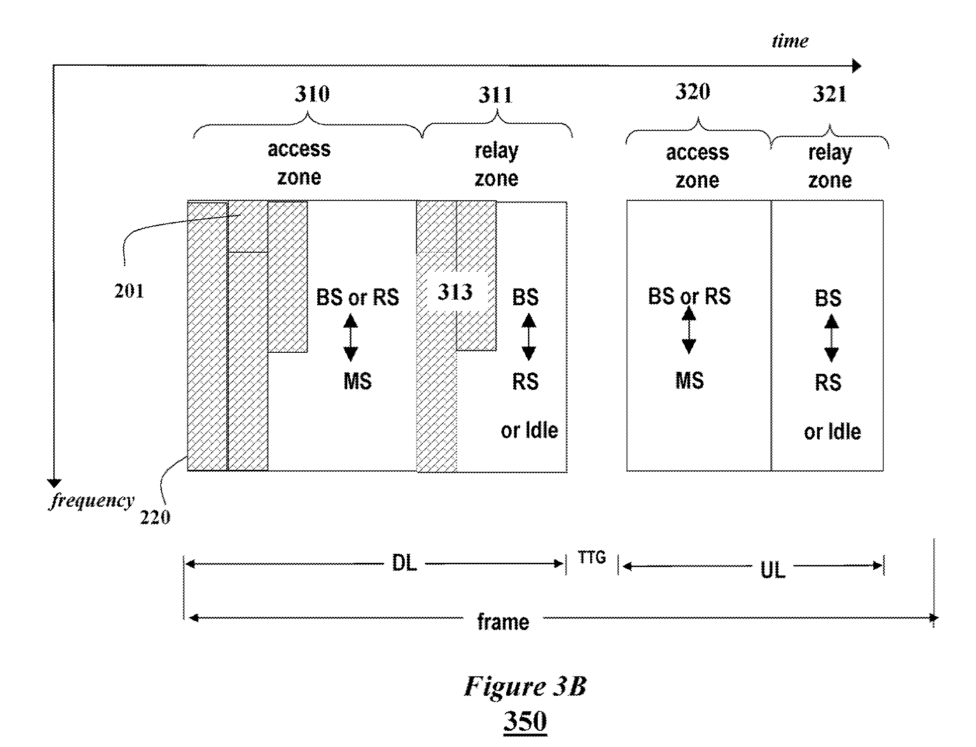

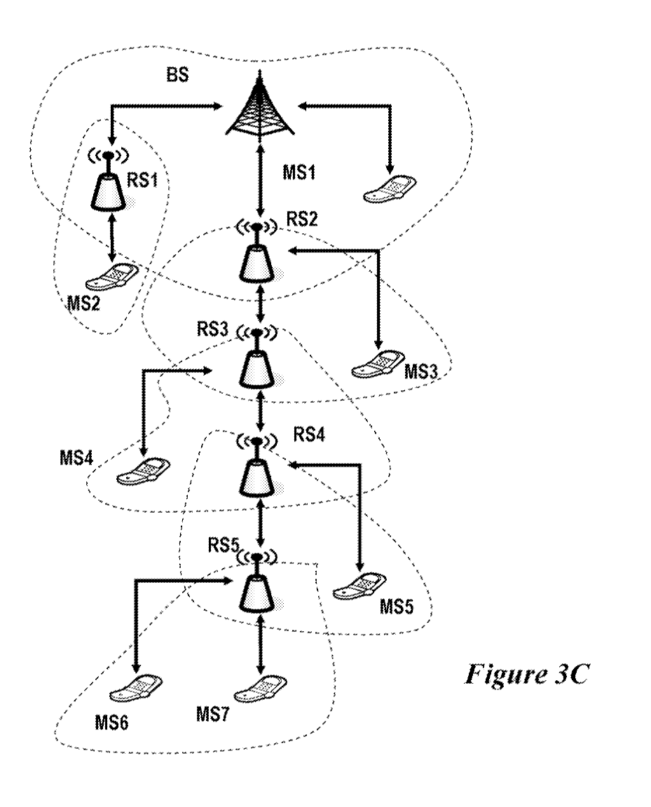

FIG. 3 A shows an example MMR including a base station, a set of relay stations, and a set of mobile stations. As defined, the set of relay stations includes at least one relay station, and the set of mobile stations includes at least on mobile station. The set of mobile stations can communicate with the set of relay stations or the base station, the set of relay stations can communicate with each other and or the base station, and only the base station communicates with the infrastructure 101. The dotted lines 301 approximately indicate the coverage areas of the relay and base stations.

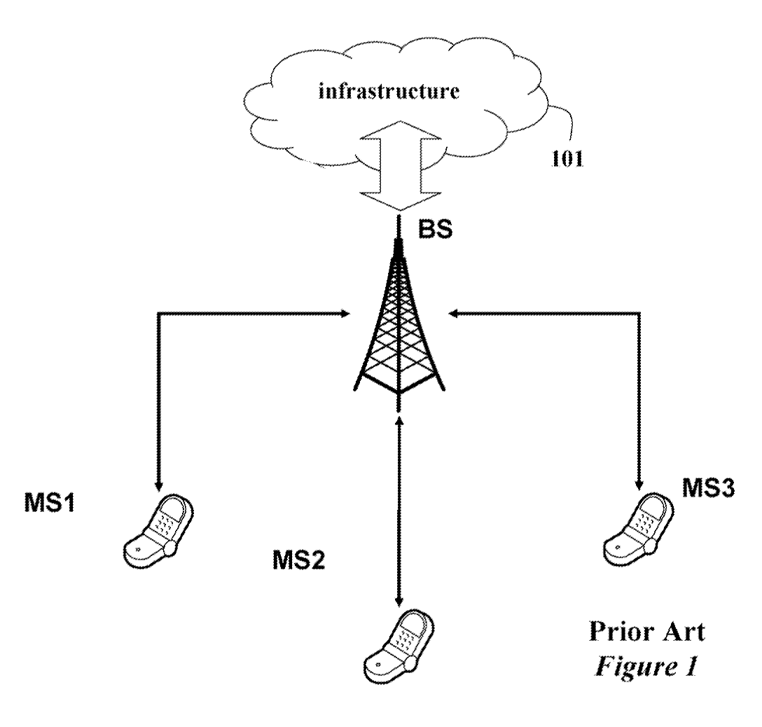

The conventional frames structure 200 is designed only for the single hop point-to-multipoint (PMP) OFDMA-based network of FIG. 1.

It is desired to modify the structure of the frame to improve performance in MMR networks.

Access and Relay Zones

As shown in FIG. 3B, the frame 350 for MMR networks according to the embodiments of the invention, also includes a downlink subframe and an uplink subframes. This maintains backward compatibility with conventional, mobile stations that are in direct transmission range of the base station or the set of relay stations.

One embodiment of the invention partitions the subframes into zones to improve the communication between the set of relay stations and the set of mobile stations, between the set of relay stations and the base station, and between the set of relay stations themselves.

The first zone in the DL subframe is a downlink access zone 310. The downlink access zone is followed by a set of downlink relay zones 311. The first zone in the UL subframe is an uplink access zone 320. The uplink access zone is followed by a set of uplink relay zones 321. As defined herein, the sets of downlink relays zones and the set of uplink relay zones can include one or more relay zones, or none at all.

During the DL access zone, the base station and the set of relay stations can only transmit to the set of mobile stations. During the DL relay zone, the base station and the set of relay stations can transceive between each other, i.e., either transmit or receive. The mobile stations are idle during the DL relay zone. The set of relay stations and the base station can also be idle during the DL relay zone.

During the UL access zone, the mobile station can only transmit to the set of relays stations and the base station. During the UL relay zone, the base station and the set of relay stations can transceive between each other, i.e., either transmit or receive.

The set of mobile stations are idle during the UL relay zone. The relay stations and the base station can also be idle during the DL relay zone.

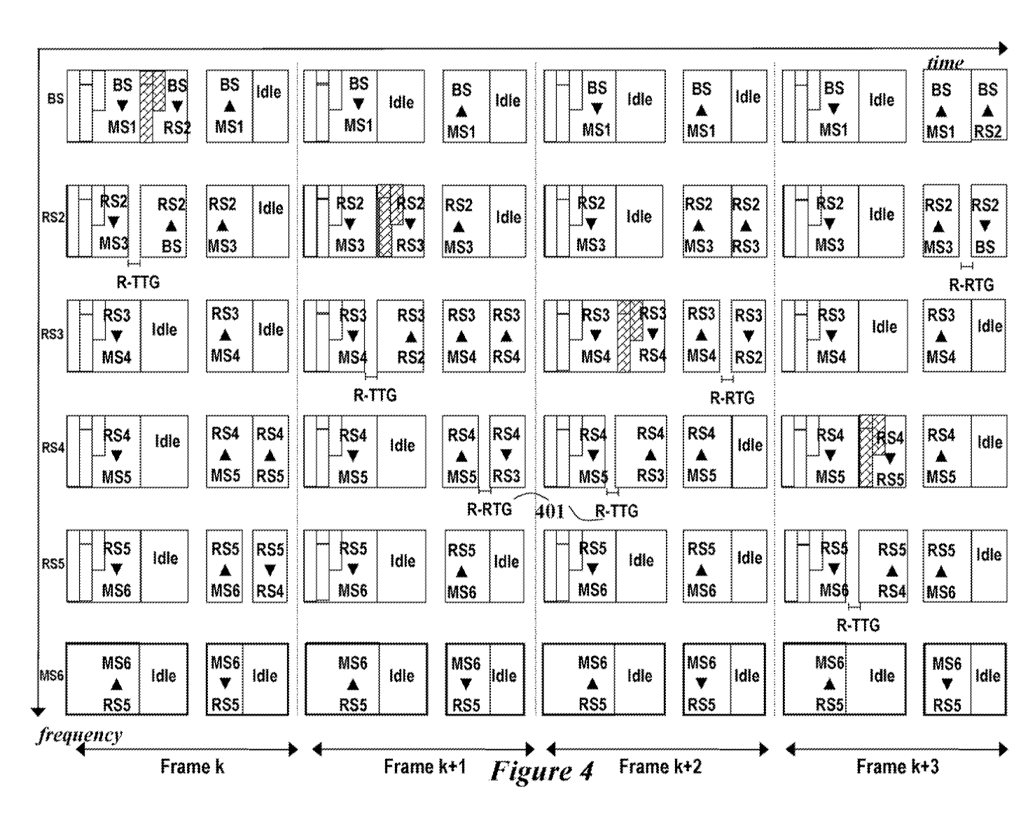

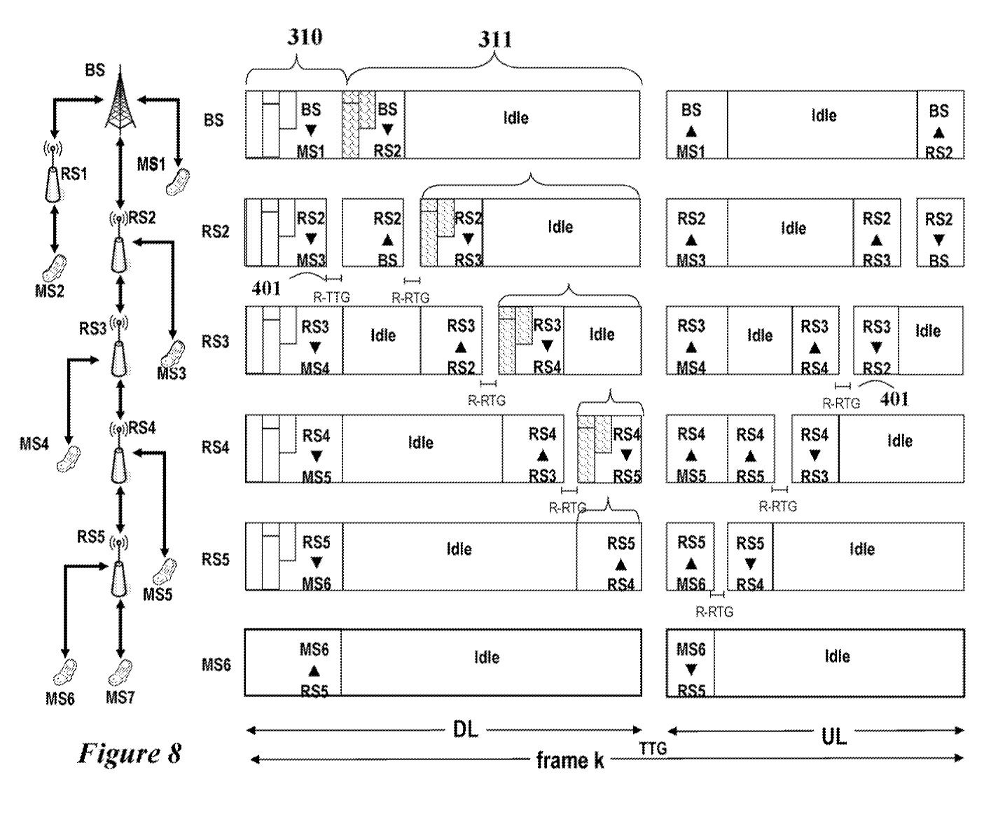

The BS or the RS can remain in the same transceive mode during the relay zone, i.e., either transmit or receive. If the BS or the RS change transceive mode, then a time gap 401, e.g., a relay transmit/receive transition gap (R-TTG) or a relay receive/transmit transition gap (R-RTG), see FIGS. 4 and 8 for examples, is inserted in the subframe between two relay zones to provide the devices with sufficient time to switch between transmit and receive modes, or between idle mode and one of the transceive modes.

The notion of the downlink subframe and uplink subframe at the BS and RS is extended because the relay zones in the downlink and uplink subframes can contain uplink or downlink transmissions.

To enable the access and relay zones, the following signaling function is used to support conventional MSs. At the beginning of each downlink access zone 320, the BS and the RSs transmit the same preamble 220 as defined in the IEEE 802.16e standard. The preamble facilitates the entry of the MS into the network, and synchronizes the MS with the BS or the RS.

Similar to the conventional frame structure, both the BS and the RS transmit the FCH 201, which is immediately followed by the downlink MAP (DL-MAP) and the uplink MAP (UL-MAP). However, the DL-MAP and UL-MAP in the MMR frame structure according to the embodiments of the invention convey information pertaining to the access and relay zone(s) in the same frame. The notion of the relay zone is transparent to conventional MSs. The MSs only become aware of the existence of the relay zone following the access zone based on the UL-MAP and DL-MAP. Thus, mobile stations are idle during the relay zones, and only the base station and the relays stations can transceive, or otherwise are idle.

When the RS enters the MMR network, the RS synchronizes to the preamble transmitted by the BS or some existent RSs. Then, the RS can extract complete information related to succeeding relay zones from the DL-MAP and the UL-MAP, and thus prepare for receiving further signaling instruction in the first downlink relay zone 311. In the first downlink relay zone, the BS or the RS transmit a relay FCH (R-FCH), a relay DL-MAP (R-DL-MAP) and a relay UL-MAP (R-UL-MAP) 313. The R-FCH specifies the length of the MAPs. The BS or the RS can also transmit a preamble during the relay zone. It should be noted that the details of fields 313 can vary.

In the case where the mobile station is far from the base station, the channel between the MS and RS is expected to have better quality than the channel between the MS and the BS. Therefore, the MAPs can be transmitted using a higher modulation scheme and less repetition coding, thereby reducing the signaling overhead. The details of the allocations for the bursts within each downlink and uplink relay zone of the current frame is provided by the R-DL-MAP and the R-UL-MAP, respectively. Moreover, the R-DL-MAP and R-UL-MAP can also indicate the partition of the access zone and relay zone(s) in following frames. This enables a flexible and adaptive frame structure configuration on a per-frame basis.

In general, the frame structure for the MMR network can be classified as inter-frame and intra-frame modes. In the inter-frame mode, each subframe contains one access zone and only one relay zone. In the intra-frame mode, each, subframe contains one access zone and multiple relay zones. The frame structure 350 described herein can accommodate both inter-frame and intra-frame modes as describe for the following examples.

FIG. 3C shows a MMR network used for the example frame structures in FIGS. 4-11. The network includes a base station (BS), five relay stations (R1-R5), and seven mobile stations (MR1-MR7). The dashed lines indicate the coverage areas for the base and relay stations.

Inter-frame Mode

Without Frequency Reuse

FIG. 4 shows an example inter-frame mode without frequency reuse. Without frequency reuse means that only one station is transmitting at any one time. As shown in FIG. 4, the BS and every RS transmits directly to the mobile stations during the downlink access zone, and the mobile stations transmit directly to the relay stations the base station during the uplink access zone.

Traffic between the BS and the MSs that are multiple-hops away from the BS is communicated in the relay zone via intermediate RSs. Because there is only one relay zone in each subframe, the propagation of traffic between the BS and MSs takes multiple frames to complete. For the BS to communicate with MS6 takes five frames. The multiple (5) frames required to communicate between the MSs and the BS (or vice versa) are called a superframe.

With Frequency Reuse and with Strict Downlink and Uplink Transmission

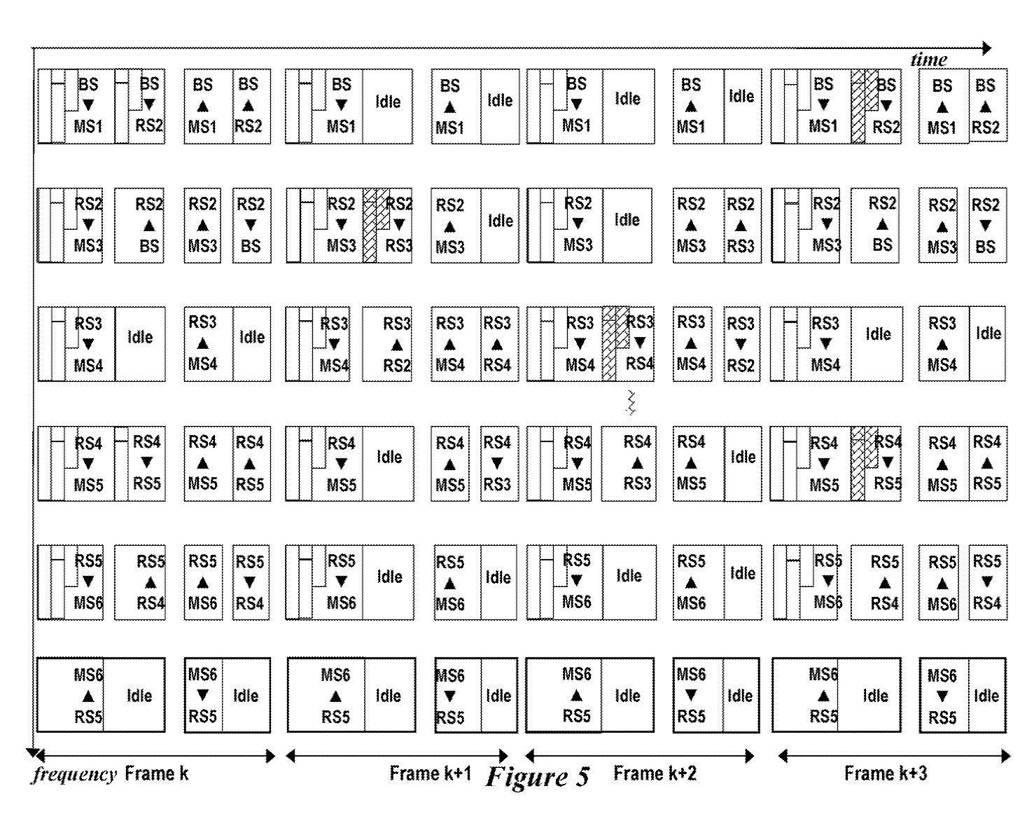

The efficiency of the framework of FIG. 4 can be improved with frequency reuse as shown in FIG. 5. The transmission from BS to RS2 in the relay zone of downlink subframe of frame K and the transmission from RS4 to RS5 in the same relay zone occur concurrently, as long as the two transmissions do not interfere each, other. The assumption here is that the RS2 and RS4 are separated by a sufficiently large distance to minimize the effect of interference.

To support frequency reuse, the BS and the RSs have to be aware of the interference sources, which requires additional functionality to measure, collect, and disseminate and between the BS and RSs.

In addition, note that the RSs in FIG. 5 follow a strict notion of downlink and uplink. That is, in the relay zone 311 of downlink subframe, BS and RS only transmit to its subordinate RS, and the RS only receives from its superordinate BS or RS. Similarly, in the relay zone 321 of uplink subframe, the BS and RS only receive from its subordinate RS, and the RS only transmits to its superordinate BS or RS.

With Frequency Reuse and without Strict Downlink and Uplink Transmission

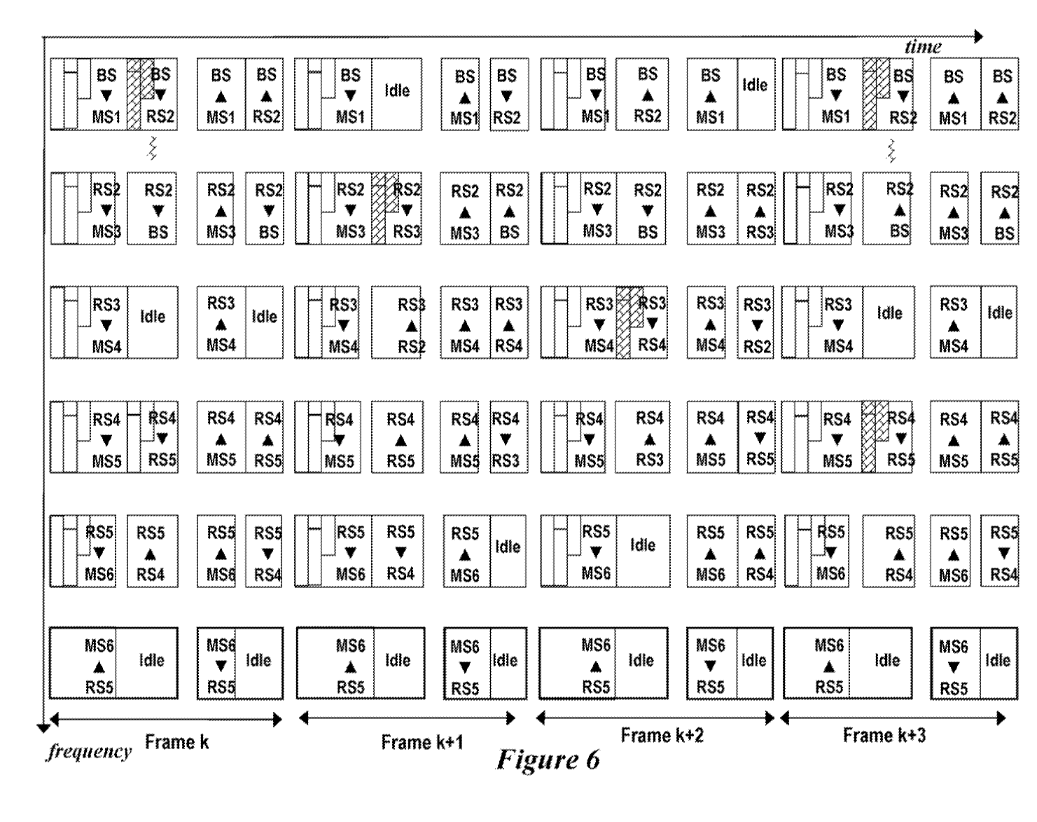

If the notion of downlink and uplink transmission is relaxed, then more instances of frequency reuse can occur as shown in FIG. 6. For example, frequency reuse occurs during the downlink and uplink relay zone of frame k, k+1, k+2 and k+3 in FIG. 6. FIG. 5 only has frequency reuse in frame k and k+3.

Without Frequency Reuse and Amble

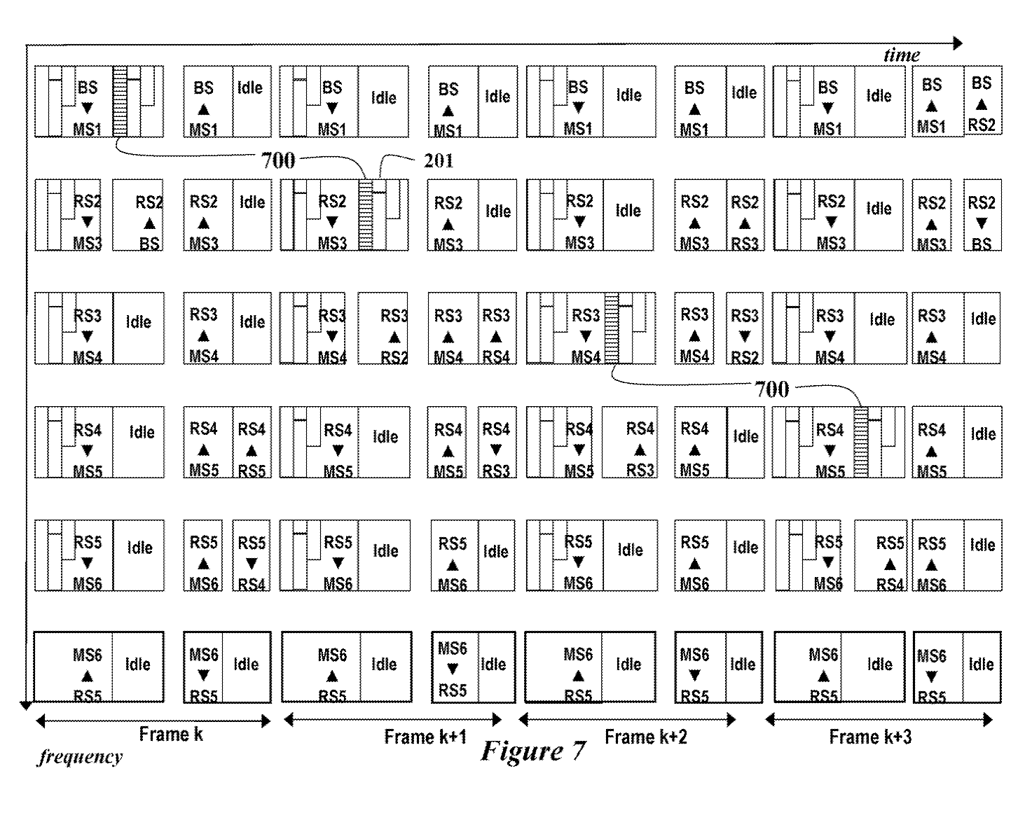

The RS can also transmit an ‘amble’ for synchronization purpose during the relay zone. Herein, an amble is defined as the field used for synchronization and channel estimation that occurs during a symbol period in the relay zone. However, the amble is elsewhere in the frame. FIG. 7 shows an example where each RS transmits the ambles 700 during the symbol at the beginning of the first downlink subframe relay zone 311 when the station is in a transmission mode. The ambles in FIG. 7 are placed in the OFDMA symbol immediately before the symbol that contains the relay FCH 313 and relay MAP. The amble can also be placed at the very end of the downlink subframe relay zone, or some other place in the downlink subframe relay zone to enable synchronization for a following subframe.

Intra-frame Mode

FIG. 8 shows the intra-frame mode, in which each subframe can contain multiple relay zones. For instance, during the first relay zone 311 of the downlink subframe of frame k, the BS transmits traffic to its subordinate RSs, which then forwards the traffic to its subordinate RS3. The forwarding repeats until the traffic is received by the corresponding access RS5, which then sends the traffic to the destination MS6 in the downlink access zone of frame K+1. During the uplink, the MS6 transmits its access RS5 during the access zone of uplink subframe. The RS5 transmits the traffic up to its superordinate RS4, which in turn transmits the traffic to its superordinate RS3. Finally, the BS receives the traffic generated by MS6 from its subordinate RS2 during the relay zone of uplink subframe. FIG. 8 also shows the R-TTG and R-RTG gaps 401 to swatch between receive, transmit or idle modes.

The differences between inter-frame mode of FIGS. 4 and the intra-mode of FIG. 8 are easily identified. The intra-frame mode delivers traffic, end to end, within one frame, thus decreasing latency. However, the decreased latency is achieved at the expense of network throughput. Each time a relay station switches between transmitting and receiving requires an additional gap in the subframe. Thus, whether to use the intra-frame or inter-frame mode, can depend on network traffic requirements.

Intra-frame with Frequency Reuse

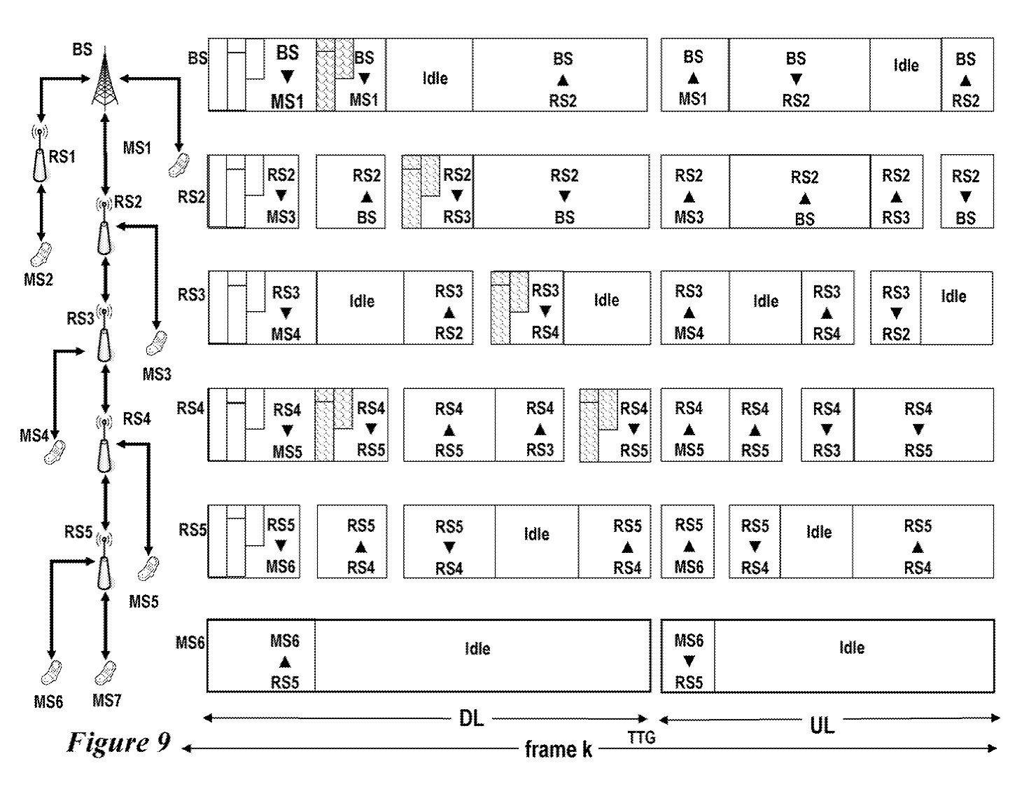

As shown in FIG. 9, frequency reuse can also improve resource utilization and network throughput in the intra-frame mode. The RS4 can transmit to RS5, while BS transmit to RS2, provided that such parallel transmission does not cause interference.

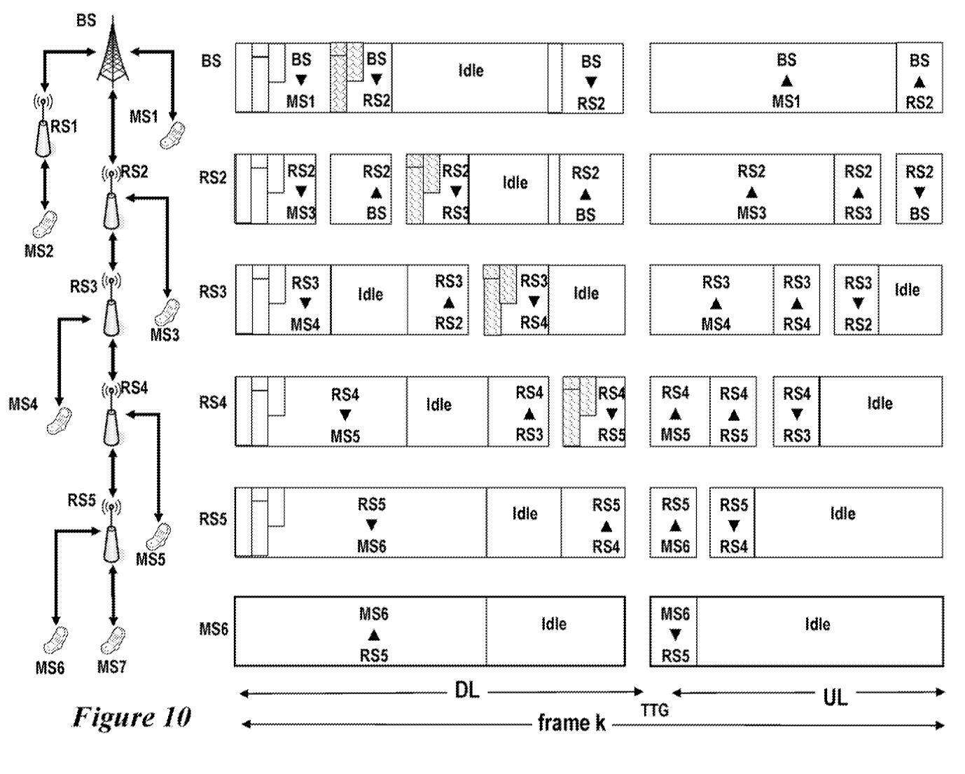

FIG. 10 shows another example of frequency reuse. For example, when the BS transmits to RS2, both RS4 and RS5 can concurrently transmit to their associated MSs, e.g., MS5 and MS6, respectively. Based on these frame structures, adaptive frequency reuse can be designed to maximize network capacity.

Without Frequency Reuse and Amble

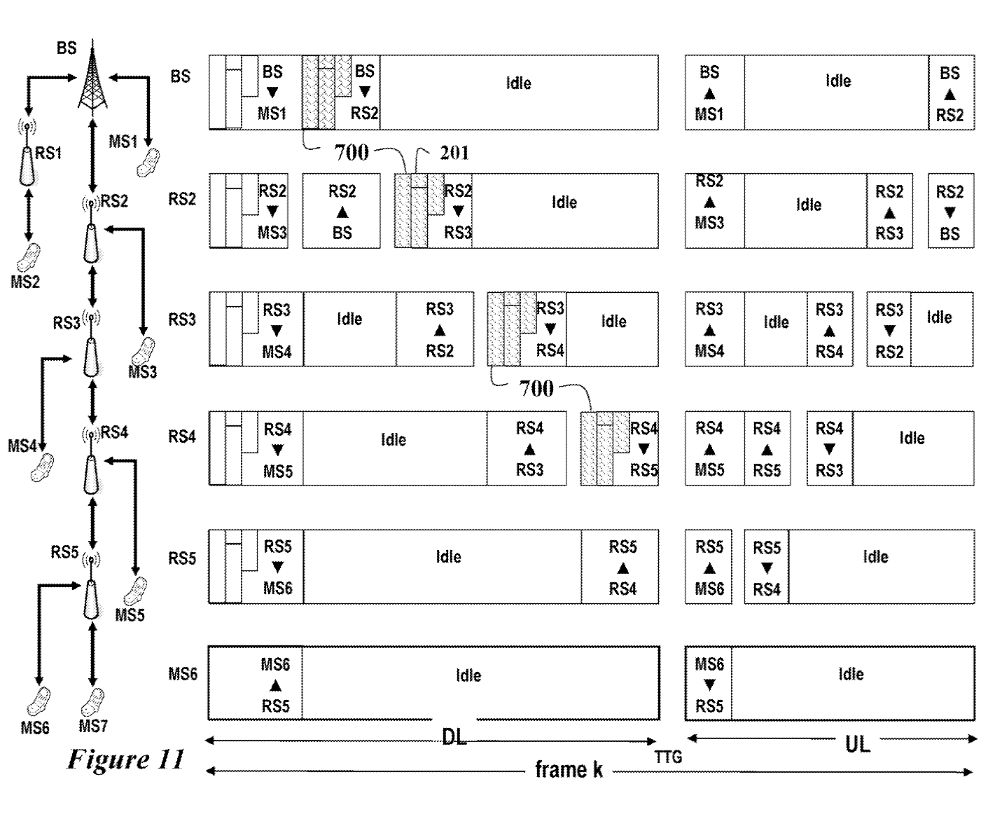

Similar to the inter-frame approach, ambles can be transmitted by the BS and the RS during the relay zone to further facilitate synchronization and other functions. As shown in FIG. 11, the BS and each RS transmit the amble 700 in the OFDMA symbol immediately before the symbol that contains the relay FCH 313 and the MAP in the first downlink subframe relay zone.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention

We claim:

1. A method for accessing channels in an orthogonal frequency division multiple access (OFDMA) mobile multihop relay wireless network, comprising:
partitioning a downlink subframe of a frame in an OFDMA-based mobile multihop relay wireless network into at least one downlink access zone and a set of downlink relay zones, in which the network includes a base station, a set of relay station and a set of mobile stations;
partitioning an uplink subframe of the frame into at least one uplink access zone and a set of uplink relay zones;
transmitting, during the downlink access zone, from the base station and the relay stations only to the set of mobile stations;
transceiving, during the downlink relay zone, between the base station and the set of relay stations, while the mobile stations associated with the base station and the set of relays stations are idle;
transmitting, during the uplink access zone, only from the set of mobile stations to set of relay stations and the base station; and
transceiving, during the uplink relay zone, between the base station and the set of relay stations, while the mobile stations associated with the base station and the set of relays stations are idle.

2. The method of claim 1, in which the set of relay stations and the base station are idle during the downlink relay zone.

3. The method of claim 1, in which the set of relay stations and the base station are idle daring the uplink relay zone.

4. The method of claim 1, further comprising:
switching between transmit mode and receive mode during the downlink subframe.

5. The method of claim 1, further comprising:
switching between transmit mode and receive mode during the uplink subframe.

6. The method of claim 4, further comprising:
inserting a gap in the subframe during the switching.

7. The method of claim 5, further comprising:
inserting a gap in the subframe during the switching.

8. The method of claim 1, further comprising:
transmitting an amble during a particular downlink relay zone.

9. The method of claim 7, further comprising:
synchronizing to the amble in the set of relay nodes.

10. The method of claim 1, further comprising:
transmitting concurrently by multiple stations during one downlink relay zone.

11. The method of claim 1, further comprising:
transmitting concurrently by multiple stations during one uplink relay zone.

12. The method of claim 1, in which a particular downlink relay zone includes a frame control header, a downlink MAP and an uplink MAP.
